(19) United States
(12) Patent Application Publication
(10) Pub. No.: US 2007/0101581 A1
(43) Pub. Date: May 10, 2007

(54) Cutter Bar of a Motor-Operated Hedge Trimmer

(75) Inventor: Winfried Carls, Gerolstein (DE)

Correspondence Address: GUDRUN E. HUCKETT DRAUDT, LONSSTR. 59, WUPPERTAL, 42289, DE

(73) Assignee: Andreas Stihl AG & Co. KG, Waiblingen (DE)

(21) Appl. No.: 11/556,222

(22) Filed: Nov. 3, 2006

(30) Foreign Application Priority Data
Nov. 8, 2005 (DE) 10 2005 053 126.1

(51) Int. Cl. B26B 19/00

(52) U.S. Cl. 30/223

(57) ABSTRACT

A cutter bar for a motor-operated hedge trimmer has a support bar and a shearing blade arranged on the support bar so as to be movable oscillatingly in a longitudinal direction of the support bar. The shearing blade has cutting teeth that project away from the support bar in a lateral direction that is perpendicular to the longitudinal direction. The cutting teeth each have an outer end remote from the support bar. At least one of the cutting teeth has at least one saw tooth that is arranged at the outer end and projects in the lateral direction away from the support bar.

### BACKGROUND OF THE INVENTION

The invention relates to a cutter bar of a motor-operated hedge trimmer. The cutter bar comprises a support bar and a shearing blade that is mounted on the support bar such that it is oscillatingly movable in the longitudinal direction of the support bar. The shearing blade has laterally projecting cutting teeth. The invention further relates to a hedge trimmer with such a cutter bar.

Hedge trimmers with a drive motor in the form of an internal combustion engine or an electric motor have a cutter bar for cutting branches of a hedge or the like. The cutter bar comprises a fixedly mounted support bar on which at least one shearing blade is guided so as to be oscillatingly movable. The shearing blade has laterally projecting cutting teeth that define a blade plane and is moved reciprocatingly in the longitudinal direction of the cutter bar by the drive motor. Additional cutting teeth are either stationary on the support bar or arranged on a second shearing blade that is moved opposite to the first shearing blade. Branches or twigs that penetrate laterally into the space between the cutting teeth are cut between the oppositely moving shearing blades.

The cross-section of the twigs or branches that can be cut by the hedge trimmer is limited by the spacing between the cutting teeth and also by the motor output that is available. When cutting hedges, shrubs or the like, it can be necessary to shorten thick branches that cannot be cut by the shearing blades of the hedge trimmer. In this case, a hand saw or a motor-driven chainsaw must be used. In addition to the required extra expenditure for tools, it is in particular disadvantageous that the freedom of movement for the auxiliary sawing tool is impaired by the surrounding branches and twigs.

EP 0 422 773 B1 discloses a hedge trimmer in which a single oscillatingly movable shearing blade is divided relative to the longitudinal direction into two sections. In the section remote from the motor, cutting teeth as they are conventional for hedge trimmers are arranged. Such cutting teeth are not present in the section of the shearing blades proximal to the motor; in this section a sawing section is arranged instead. By means of the saw teeth of the oscillatingly driven sawing section it is possible to cut even thick branches. It is a disadvantage that thin elastic twigs in the vicinity of the area where the sawing cut is to be performed will hinder the sawing step. In any of the selected available operating types, i.e., either shearing operation or sawing operation, the section of the cutter bar that is not currently in use may also impair the work to be performed.

### SUMMARY OF THE INVENTION

It is an object of the present invention to configure a cutter bar of the aforementioned kind such that the range of cutting tasks to be performed is broadened.

In accordance with the present invention, this is achieved in that at least one cutting tooth has at its outer end at least one saw tooth projecting in the lateral direction.

It is another object of the present invention to provide a hedge trimmer with improved cutting performance.

In accordance with the present invention, this is achieved in that the hedge trimmer is provided with a cutter bar having at least one cutting tooth that has at its outer end at least one saw tooth projecting in the lateral direction.

A cutter bar of a motor-operated hedge trimmer and a hedge trimmer provided with such a cutter bar are proposed wherein the cutter bar has a support bar and a shearing blade that is mounted on the support bar so as to be oscillatingly moveable in the longitudinal direction of the cutter bar, wherein the shearing blade is provided with cutting teeth projecting in the lateral direction (transverse to the longitudinal direction). According to the invention, it is proposed that at least one cutting tooth has at its outer end at least one saw tooth that projects in the lateral direction. Cutting teeth that are configured in this way provide a mutually supplemental double function. It is possible to perform with them a conventional shearing operation for cutting twigs or branches as well as a sawing operation for cutting thick branches. The aforementioned double function enables simple working with increased freedom of movement. The cutter bar can be inserted into thick brush and thin twigs are cut off by shearing action. The one or more outwardly positioned saw teeth support the cutting operation. As soon as the cutter bar encounters a thick branch or the like, the hedge trimmer automatically, without positional change, begins to perform a sawing operation that reliably cuts the branch. The surrounding thin twigs are at the same time cut by shearing action and do not impair the sawing process.

In an advantageous embodiment, several cutting teeth arranged adjacent one another on one lateral side of the shearing blade have at their outer ends at least one saw tooth each. Across the longitudinal extension of the neighboring cutting teeth, a sawing area is provided in this way and this sawing area is covered by the oscillating stroke movement of the shearing blade. In addition to increasing the saw area, it is also achieved that the neighboring cutting teeth, while maintaining their shearing action, form at their outer ends a continuous straight cutting line comparable to a continuous sawblade; this facilitates a steady and precise cutting action. For enhancing this effect, it can be expedient to arrange two or more saw teeth on the outer end of a cutting tooth.

The shearing blade is expediently provided with saw teeth on both opposite lateral sides. The user can immerse the cutting bar in both lateral directions, as needed, into the branches or twigs to be cut. A positional change of the hedge trimmer when encountering thick branches is not required.

In an advantageous embodiment, two shearing blades are provided that are guided to move oscillatingly in the longitudinal direction in opposite moving directions wherein correlated cutting teeth of both shearing blades have at their outer ends at least one saw tooth, respectively. The saw teeth of the correlated cutting teeth move in opposite directions as do the corresponding shearing blades. In connection with their direct spatial proximity relative to one another, the occurring cutting forces cancel one another at least approximately. An undesirable oscillation excitation of the branch to be cut as well as reaction forces on the cutter bar are prevented or at least reduced.

The saw teeth of the two oppositely moving shearing blades can be arranged with their cutting edges in the same cutting direction so that the respective saw teeth of the two shearing blades as a result of their opposite movement carry out alternatingly a cut with identical orientation. Preferably, the saw teeth of the two shearing blades are arranged in opposite directions to one another. Their cutting edges face in opposite directions. In connection with the opposite movement of the two shearing blades, a working stroke of the two shearing blades is carried out simultaneously in that the saw teeth carry out simultaneously a sawing cut in opposite directions. The occurring cutting forces in the stroke direction or in the longitudinal direction cancel one another at least approximately. The same holds true also for the subsequent stroke of the cutting cycle that is carried out opposite to the cutting direction; when this is done, no cut is performed. However, the remaining forces such as friction forces or inertia forces are canceled at least approximately. The running smoothness of the hedge trimmer as well as the guiding precision of the hedge trimmer are increased.

For further enhancing the running smoothness and guiding precision of the hedge trimmer, the saw teeth of the two shearing blades are shaped mirror-symmetrical to one another relative to the lateral direction. It is ensured that on the saw teeth of both shearing blades at least approximately the same cutting forces and the same cutting output occur; this also contributes to running smoothness of the hedge trimmer with excellent guiding precision.

### BRIEF DESCRIPTION OF THE DRAWING

FIG. 1 is a perspective illustration of a hedge trimmer with cutter bar whose cutting teeth are provided at their outer ends with saw teeth.

FIG. 2 is a schematic detail illustration of the cutter bar of FIG. 1 with details of the saw teeth provided at the outer ends at the forwardly positioned cutting teeth.

FIG. 3 is an enlarged detail view of the cutting teeth according to FIG. 2 with details of the saw tooth geometry.

### DESCRIPTION OF THE PREFERRED EMBODIMENTS

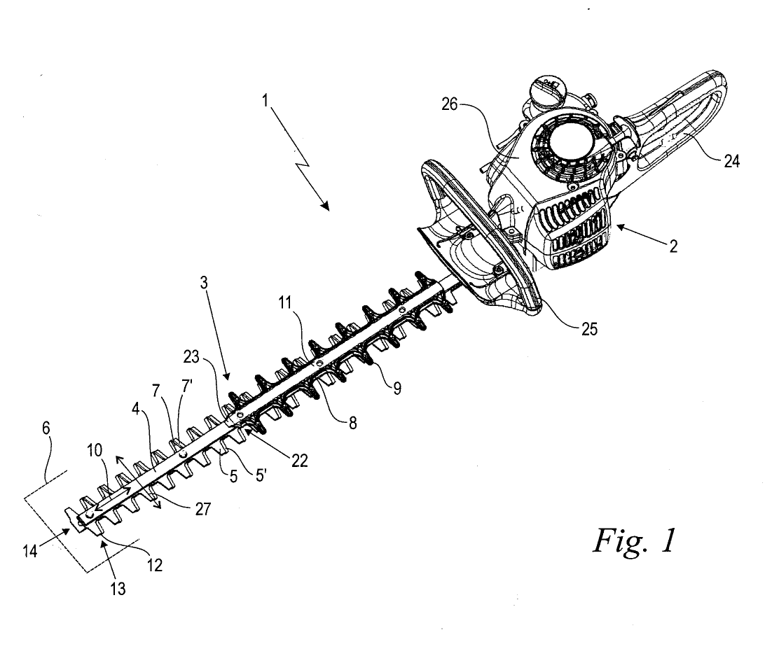

The hedge trimmer 1 according to FIG. 1 comprises a motor part with a motor housing 26 in which a motor 2 in the form of an internal combustion engine, not illustrated in detail, is arranged for driving the hedge trimmer 1. It is also possible to provide an electric motor. The cutter bar 3 is connected to the motor part and is driven in operation by the motor 2. For guiding the hedge trimmer 1, a first bow-shaped grip 25 is provided on the side of the motor part facing the cutter bar 3 and a second grip 24 is provided on the opposite rear side of the motor part.

The cutter bar 3 extends in the longitudinal direction 10 and comprises a support bar 4 that is rigidly and fixedly connected to the motor part. Two oppositely driven shearing blades 5, 5′ are guided on the support bar 4 so as to be movable in the longitudinal direction 10. The shearing blades 5 and 5′, driven by the motor 2, carry out opposite oscillating movements in the longitudinal direction 10. The shearing blades 5, 5′ have on opposite lateral sides cutting teeth 7, 7′ that project in the lateral direction 27 and define a blade plane 6. The cutting teeth 7 and the shearing blade 5 are formed as a monolithic part, and the cutting teeth 7′ and the shearing blade 5′ are formed as a monolithic part. As a result of the opposite movement of the cutting teeth 7, 7′ in the longitudinal direction 10, twigs that are inserted into the intermediate spaces between the cutting teeth 7, 7′, are cut. An embodiment may also be expedient in which a single movable shearing blade 5 is provided and appropriate counteracting cutting teeth are arranged on the stationary support bar 4.

The cutter bar 3 is provided at the longitudinal area adjoining the front grip 25 with a cutting protector 8 which is comprised of a centrally arranged longitudinal support 11 extending in the longitudinal direction 10 and of laterally projecting protective fingers 9 extending in opposite lateral directions. An arrangement may also be advantageous in which the cutting protector 8 extends across the entire length of the cutter bar 3. The cutting protector 8 with its longitudinal support 11 and the protective fingers 9 is manufactured as a monolithic part from an impact-resistant plastic material and is connected fixedly, i.e., so as to be immobile, on the support bar 4. On the free end 22 facing away from the grip 25, the longitudinal support 11 is provided with a ramp 23 that ascends, starting at the surface of the support bar 4, in the longitudinal direction 10 and therefore provides a threading means for a transport protector that can be pushed onto the cutter bar 3 as needed.

The protective fingers 9 are positioned parallel to the blade plane 6 at a minimal spacing above the blade plane 6 so that the oscillating movement of the cutting teeth 7 can be performed at a minimal spacing below the fingers 9 without any hindrance.

The cutting teeth 7, 7′ and the protective fingers 9 extend in the lateral direction 27 that extends transversely to the longitudinal direction 10, wherein the longitudinal direction 10 and the lateral direction 27 define the position of the blade plane 6.

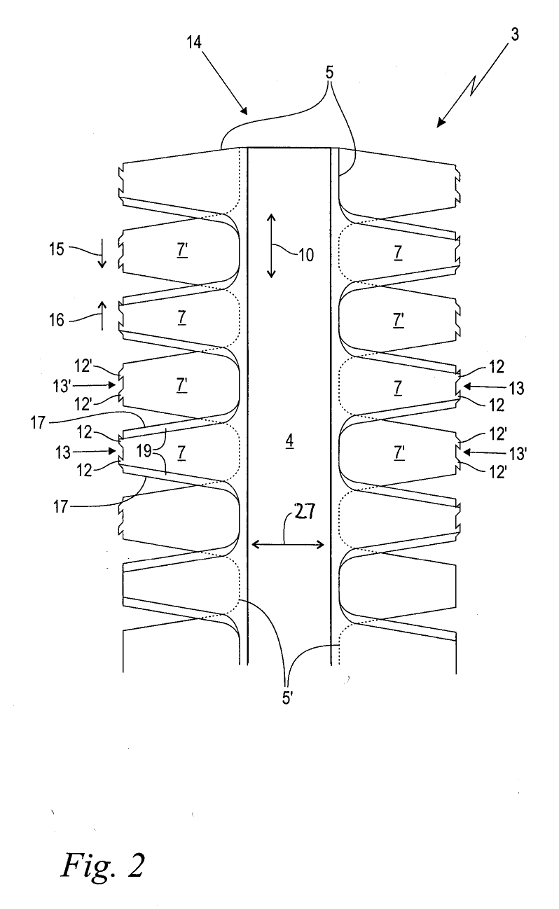

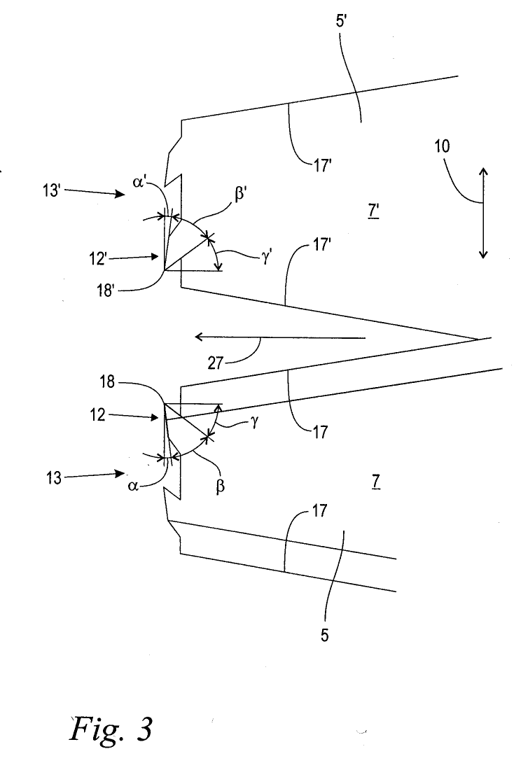

In the area of a free end 14 of the cutter bar 3 (see FIG. 1), several of the cutting teeth 7, 7′ are provided at their outer ends 13 with saw teeth 12 that project in the lateral direction 27; in oder to simplify the illustration, the teeth 12 are not shown in detail. The configuration of the cutting teeth 12 will be explained in more detail in connection with FIGS. 2 and 3.

In operation, the operator moves the cutter bar 3 as desired into the branches and twigs to be cut in one of the lateral directions 27. When doing so, thin branches will reach the intermediate spaces between the cutting teeth 7, 7′ and are cut by the cutting edges 17, 17′ arranged thereat at and illustrated in FIG. 3 by a shearing action. The entire longitudinal area of the cutter bar 3 including the area of the cutting protector 8 are available for this purpose. When hitting thick objects such as branches or the like, the cutting protector 8 prevents the cutting teeth 7, 7′ from contacting the branches. Thick branches that contact in the lateral direction 27 the outer end 13 of the cutting teeth 7, 7′ in the area of the free end 14 of the cutter bar 3 are separated by a sawing action by means of the saw teeth 12 arranged thereat while the neighboring thin twigs at the same time are sheared off by the cutting edges 17, 17′ (FIG. 3) of the cutting teeth 7, 7′.

FIG. 2 shows a schematic plan view onto the cutter bar 3 according to FIG. 1 in the area of its free end 14. The shearing blade 5 is provided on both lateral sides of the support bar 4 with a plurality of cutting teeth 7 formed together with the shearing blade as a unitary part; the cutting teeth 7 extend in the lateral direction 27. The second shearing blade 5 is substantially identical. The cutting teeth 7′ are staggered relative to the cutting teeth 7 of the shearing blade 5 in the longitudinal direction 10.

The cutting teeth 7, relative to the longitudinal direction 10, are provided on both opposite sides with slanted surfaces 19 that extend from the shown topside into one of the cutting edges 17, respectively. Similarly, the cutting teeth 7′ on the bottom side (not illustrated) are provided with slanted surfaces (not illustrated) so that the cutting edges 17′ illustrated in FIG. 3 are formed. The two shearing blades 5, 5′ rest against one another without play so that the cutting edges 17, 17′ illustrated in FIG. 3 glide on one another and perform a shearing movement for cutting twigs and thin branches.

The two shearing blades 5, 5′ are driven in oscillation in opposite directions in the longitudinal direction 10; as the cutting teeth 7 are moved in the direction of arrow 16, a uniform movement of the cutting teeth 7′ in the direction of arrow 15 is realized. Relative to the support bar 4, the speed of movement of the two shearing blades 5, 5′ is identical but movement occurs in opposite directions.

The cutting teeth 7, 7′ of both shearing blades 5, 5′ are provided at their outer ends 13, 13′ with saw teeth 12, 12′ projecting in the lateral direction 27. In the illustrated embodiment, the individual outer ends 13, 13′ are provided with two saw teeth 12, 12′ each. It is also possible to provide a different number of saw teeth 12, 12′. The saw teeth 12, 12′ are arranged on the cutting teeth 7, 7′ on both lateral sides of the support bar 4, i.e., on both lateral sides of the shearing blades 5, 5′. It may also be expedient to provide an arrangement of saw teeth only on one lateral side.

In the illustrated embodiment, on each lateral side of the support bar 4 there are three cutting teeth 7 neighboring one another in the longitudinal direction 10 that are provided with saw teeth 12; these cutting teeth 7 adjoin directly the free end 14. The same holds true for the cutting teeth 7′ of the shearing blade 5′ that are provided with saw teeth 12′ so that a total of twelve cutting teeth 7, 7′ are provided with saw teeth 12, 12′. It can also be expedient to provide a different number, in particular a larger number of cutting teeth 7, 7′, with saw teeth 12, 12′ so as to cover in particular the longitudinal area from the free end 14 to the cutting protector 8 (see FIG. 1).

It can be seen that the slanted surfaces 19 beginning at the foot area of the cutting teeth 7 that adjoins the support bar 4 in the lateral direction 27 extend to the outer ends 13 and in this way also overlap the saw teeth 12. The cutting edges 17 therefore pass in the corner area at the outer ends 13 directly into the adjoining saw tooth 12.

The illustration according to FIG. 2 shows that in shearing operation one pair of correlated cutting teeth 7, 7′ interact with one another. Each of the illustrated pairs of cutting teeth 7, 7′ is provided with saw teeth 12, 12′ that are arranged in opposite directions relative to the longitudinal direction 10 and during the sawing operation also interact with one another. When looking also at the illustration of FIG. 3, the sawing edges 18 of the saw teeth 12 when performing a movement in the direction of arrow 16 perform a sawing cut while at the same time the sawing edges 18′ of the saw teeth 12′ are moved in the opposite direction according to arrow 15 and also carry out a sawing cut. The cutting forces that occur in the direction of arrows 15, 16 and in the longitudinal direction 10 cancel one another approximately.

FIG. 3 shows an enlarged detail view of two cutting teeth 7, 7′ of the arrangement according to FIG. 2 in the area of their outer ends 13, 13′. It can be seen that the geometry of the saw teeth 12 with their sawing edges 18 is defined by a clearance angle α (alpha), a wedge angle β (beta), and a cutting angle γ (gamma). The aforementioned angles are positioned in the blade plane 6 according to FIG. 1 so that the sawing edges 18, 18′ extend at least approximately in the vertical direction that is perpendicular to the blade plane 6. The wedge angle β (beta) is selected such that, according to conventional definition, a positive clearance angle α (alpha) and a positive cutting angle γ (gamma) are formed relative to the lateral direction 27 and the longitudinal direction 10. A different type of cutting geometry may also be expedient.

The saw teeth 12′ with the cutting edges 18′ have a clearance angle α′ (alpha′), a wedge angle β′ (beta′), and a cutting angle α′ (alpha′); these angles are identical to the clearance angle α (alpha), the wedge angle β (beta), and the cutting angle γ (gamma) of the saw teeth 12 but are oriented in the opposite direction. This has the result that the saw teeth 12 of the shearing blade 5 and the saw teeth 12′ of the additional shearing blade 5′ are mirror-symmetrical to one another relative to the lateral direction 27 used as an axis of reflection wherein the sawing edges 18, 18′ that are correlated with one another face one another.

The saw teeth 12, 12′ have in their direction of thickness a constant contour shown in FIG. 3. It can also be expedient to grind the saw teeth 12, 12′ in the direction of thickness. In this connection, either a pair of saw teeth 12 or a pair of saw teeth 12′ can be configured as alternating teeth. Also, it can be advantageous to configure the saw teeth 12 relative to the direction of thickness mirror-symmetrical to the correlated saw teeth 12′, wherein the saw teeth 12 together with correlated saw teeth 12′ form an alternating tooth arrangement.

The specification incorporates by reference the entire disclosure of German priority document 10 2005 053 126.1 having a filing date of 8 Nov. 2005.

While specific embodiments of the invention have been shown and described in detail to illustrate the inventive principles, it will be understood that the invention may be embodied otherwise without departing from such principles.

What is claimed is:

1. A cutter bar for a motor-operated hedge trimmer, the cutter bar comprising:
a support bar;
a shearing blade arranged on the support bar so as to be movable oscillatingly in a longitudinal direction of the support bar;
the shearing blade having cutting teeth, wherein the cutting teeth project away from the support bar in a lateral direction that is perpendicular to the longitudinal direction and wherein the cutting teeth each have an outer end remote from the support bar;
at least one of the cutting teeth having at least one saw tooth that is arranged at the outer end and projects in the lateral direction away from the support bar.

2. The cutter bar according to claim 1, wherein several of the at least one of the cutting teeth having at least one saw tooth are provided adjacent to one another on a lateral side of the shearing blade.

3. The cutter bar according to claim 1, wherein several of the at least one of the cutting teeth having at least one saw tooth are provided on opposite lateral sides of the shearing blade.

4. The cutter bar according to claim 1, wherein a first one of the shearing blade and a second one of the shearing blade are arranged on the support bar so as to move oscillatingly in opposite directions relative to one another, wherein the first one of the shearing blade and the second one of the shearing blade each have several of said at least one of the cutting teeth having at least one saw tooth that are neighboring one another within the first one of the shearing blade and the second one of shearing blade, respectively, and are correlated with one another regarding interaction between the first one of the shearing blade and the second one of the shearing blade for performing a cut.

5. The cutter bar according to claim 4, wherein said at least one saw tooth of the at least one of the cutting teeth of the first one of the shearing blade and said at least one saw tooth of the at least one of the cutting teeth of the second shearing blade face in opposite directions.

6. The cutter bar according to claim 5, wherein said at least one saw tooth of the at least one of the cutting teeth of the first one of the shearing blade and said at least one saw tooth of the at least one of the cutting teeth of the second shearing blade are mirror-symmetrical to one another relative to the lateral direction.

7. The cutter bar according to claim 1, wherein the at least one cutting tooth having at least one saw tooth has two or more of said at least one saw tooth arranged on the outer end.

8. A motor-operated hedge trimmer having a cutter bar according to claim 1.
